(19) United States
(12) Patent Application Publication
(10) Pub. No.: US 2025/0371313 A1
(43) Pub. Date: Dec. 4, 2025

(54) HYBRID NEURAL NETWORK APPARATUS AND OPERATING METHOD THEREOF

(71) Applicant: Electronics and Telecommunications Research Institute, Daejeon (KR)

(72) Inventors: Tae Wook KANG, Daejeon (KR); Kwang OH, II, Daejeon (KR); Jae Jin LEE, Daejeon (KR); Hyeong Uk JANG, Daejeon (KR); Sung Eun KIM, Daejeon (KR); Hyuk KIM, Daejeon (KR)

(73) Assignee: Electronics and Telecommunications Research Institute, Daejeon (KR)

(21) Appl. No.: 19/093,444

(22) Filed: Mar. 28, 2025

(30) Foreign Application Priority Data
May 30, 2024 (KR) 10-2024-0070537

(51) Int. Cl. G06N 3/045; G06N 3/049

(52) U.S. Cl. CPC G06N 3/045; G06N 3/049

(57) ABSTRACT

The present invention relates to a hybrid neural network apparatus. The hybrid neural network apparatus includes an input layer group comprising at least one analog neural network (ANN) layer and trained by information or data input from an application system, an intermediate layer group comprising at least one spiking neural network (SNN) layer and trained by a received training result of the input layer group, and an output layer group comprising at least one ANN layer, trained by a received training result of the intermediate layer group, and then outputting a final training result to the application system.

### CROSS-REFERENCE TO RELATED APPLICATION

This application claims priority to and the benefit of Korean Patent Application No. 10-2024-0070537, filed on May 30, 2024, the disclosure of which is incorporated herein by reference in its entirety.

### BACKGROUND

### 1. Field of the Invention

The present invention relates to a hybrid neural network apparatus including an analog neural network (ANN) and a spiking neural network (SNN), and an operating method thereof.

### 2. Discussion of Related Art

An analog neural network (ANN) may perform training and inference signal processing of the network by transmitting data expressed as level values.

Unlike the existing ANN, a spiking neural network (SNN) is a method in which information is transmitted using binary representable spike signals having a pulse form that toggles for a short period of time rather than a specific level of signal between neurons, and has the advantage of low-power operation.

However, in order to use the spiking neural network (SNN), there is a problem in that additional configuration for a spike signal conversion for input of the SNN for ANN application input data that generally has a level value, a loss function calculation required for training at each spike time step for an SNN output spike signal and time delay due to the loss function calculation, spike-to-level value conversion for level value input in application systems, etc., is required.

Therefore, there is a need for a technology for a hybrid neural network apparatus that may minimize the complexity of information or data conversion between the ANN and the SNN while using the SNN for low-power operation, that is, may utilize the advantages of the ANN and the SNN.

The background technology of the present invention is disclosed in Korean Patent Publication No. 10-2023-0096657 (published on Jun. 30, 2023).

### SUMMARY OF THE INVENTION

The present invention is directed to providing a hybrid neural network apparatus including an analog neural network (ANN) and a spiking neural network (SNN), and an operating method thereof.

In addition, the present invention is directed to providing a hybrid neural network apparatus for converting a transmission information data form between an output spike signal of an SNN and an input level value of an ANN when layers of the SNN are configured between layers of the ANN in one neural network system together, and an operating method thereof.

According to an aspect of the present invention, there is provided a hybrid neural network apparatus, including an input layer group comprising at least one analog neural network (ANN) layer and trained by information or data input from an application system, an intermediate layer group comprising at least one spiking neural network (SNN) layer and trained using a received training result of the input layer group, and an output layer group comprising at least one ANN layer, trained by the received training result of the intermediate layer group, and then outputting a final training result to the application system.

Operations of the input layer group, the intermediate layer group, the output layer group, and each ANN layer and each SNN layer in each layer group may be performed under control of a processor.

The information or data input from the application system may be normalized to have a size or form suitable for an input of each ANN layer in the input layer group.

When connecting from the ANN layer in the input layer group to the SNN layer in the intermediate layer group, an output neuron of the ANN layer may transmit the information or data to an input neuron of the connected SNN layer.

The output neuron of the ANN layer may convert the output data level value into the number of spikes corresponding to a rate proportional to a size of the output data level value of the output neuron in the ANN layer and transmit the number of spikes to each input neuron of the SNN layer.

When connecting from the SNN layer in the intermediate layer group to the ANN layer in the output layer group, an output neuron of the SNN layer may transmit the information or data to an input neuron of the connected ANN layer.

The output neuron of the SNN layer may convert a spike signal into a level value and transmit the level value.

The output neuron of the SNN layer may transmit, as the level value of the input neuron of the ANN, a value obtained by dividing a sum of the number of spike firings fired during an N time step of the spike signal by N when an activation function is applied.

When an activation function is not applied, the output neuron of the SNN layer may transmit a level value calculated by dividing a final accumulated value of a membrane potential of the output neuron of the SNN by N as the level value of the input neuron of the ANN layer.

The membrane potential of the output neuron of the SNN layer may be determined by a sum of values obtained by multiplying the spike signals fired from each input neuron connected by synapses by weights of the corresponding synapses.

The output neuron of the SNN layer may fire a spike when the membrane potential of the output neuron of the SNN layer becomes greater than a specified threshold value, and the membrane potential of the corresponding SNN output neuron that fires the spike may be lowered by subtracting the threshold value, or initialized to 0.

According to another aspect of the present invention, there is provided a method of operating a hybrid neural network apparatus, including training an input layer group comprising at least one analog neural network (ANN) layer using information or data input from an application system, training an intermediate layer group comprising at least one spiking neural network (SNN) layer by a received training result of the input layer group, and training an output layer group comprising at least one ANN layer by a received training result of the intermediate layer group, and then outputting a final training result to the application system.

The information or data input from the application system may be normalized to have a size or form suitable for an input of each ANN layer in the input layer group.

When connecting from the ANN layer in the input layer group to the SNN layer in the intermediate layer group, an output neuron of the ANN layer may transmit information or data to an input neuron of the connected SNN layer.

The output neuron of the ANN layer may convert the output data level value into the number of spikes corresponding to a rate proportional to a size of the output data level value of the output neuron in the ANN layer and transmit the number of spikes to each input neuron of the SNN layer.

When connecting from the SNN layer in the intermediate layer group to the ANN layer in the output layer group, an output neuron of the SNN layer may transmit the information or data to an input neuron of the connected ANN layer.

The output neuron of the SNN layer may convert a spike signal into a level value and transmit the level value.

The output neuron of the SNN layer may transmit, as the level value of the input neuron of the ANN, a value obtained by dividing a sum of the number of spike firings fired during an N time step of the spike signal by N when an activation function is applied.

When an activation function is not applied, the output neuron of the SNN layer may transmit a level value calculated by dividing a final accumulated value of a membrane potential of the output neuron of the SNN by N as the level value of the input neuron of the ANN layer.

The membrane potential of the output neuron of the SNN layer may be determined by a sum of values obtained by multiplying the spike signals fired from each input neuron connected by synapses by weights of the corresponding synapses.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a schematic configuration of a hybrid neural network apparatus according to an embodiment of the present invention;

FIGS. 2 and 3 are exemplary diagrams for describing a signal conversion method when transmitting information from a spiking neural network (SNN) layer to an analog neural network (ANN) layer in FIG. 1; and

FIG. 4 is a flowchart for describing a method of operating a hybrid neural network apparatus of an SNN and an ANN according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an embodiment of a hybrid neural network apparatus and an operating method thereof according to an embodiment of the present invention will be described.

The present invention relates to a hybrid neural network apparatus in which the inefficiency of a spike conversion of a level value input is eliminated from an application system for a neural network and a loss function calculation of an output value in units of spikes, and which enables a low-power operation through spike signal processing by applying a spiking neural network (SNN), and an operating method thereof.

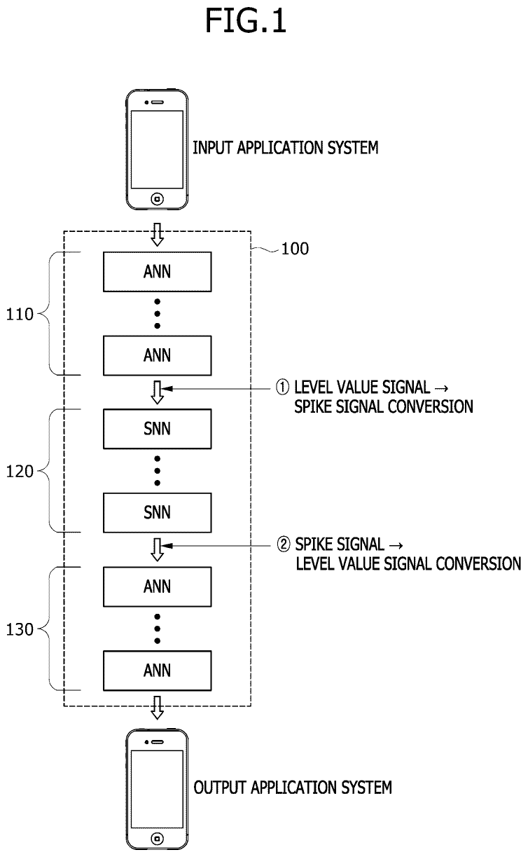

FIG. 1 is an exemplary diagram illustrating a schematic configuration of a hybrid neural network apparatus according to an embodiment of the present invention.

As illustrated in FIG. 1, a hybrid neural network apparatus 100 according to the present embodiment includes an input layer group 110 (first layer group), an intermediate layer group 120 (second layer group), and an output layer group 130 (third layer group).

After each ANN layer of the input layer group 110 trains the values input from the application system, each SNN layer is trained by transmitting the training result of the input layer group 110 to the intermediate layer group 120, and each ANN layer is trained by transmits the training results of the intermediate layer group 120 to the output layer group 130, the final training results are transmitted to the application system.

In this case, although the present embodiment describes that the input layer group 110, the intermediate layer group 120, and the output layer group 130 output a final training result through sequential training, it should be understood that each layer group 110 to 130 is not trained independently, but each layer group 110 to 130 may be trained (calculated) as a single neural network group (i.e., all network layers are included and trained by forward propagation and backward propagation).

Meanwhile, although not specifically illustrated in the drawings, the operation of each layer group 110 to 130 and each layer (e.g., ANN layer and SNN layer) within each layer group 110 to 130 may be performed by a processor (not illustrated).

The input layer group 110 comprises at least one ANN layer, the intermediate layer group 120 comprises at least one SNN layer, and the output layer group 130 comprises at least one ANN layer.

In this way, the present embodiment may configure a hybrid neural network such as a multi-layer perceptron (MLP) using the ANN and the SNN.

Referring to FIG. 1, information (or data) input to the hybrid neural network apparatus 100 in the application system is generally data having a level value.

In this case, the information (or data) input to the neural network is normalized to have a size (or form) suitable for an input of each ANN layer in the input layer group 110 which is a first layer in the hybrid neural network apparatus 100 of the ANN and the SNN.

Referring back to FIG. 1, when connecting from the ANN layer in the input layer group 110 to the SNN layer in the intermediate layer group 120 (\textcircled{1}), an output neuron of the ANN layer transmits (inputs) information (or data) to an input neuron of the connected SNN layer. In this way, when transmitting the information (or data) from the ANN layer to the SNN layer (\textcircled{1}), the output neuron of the ANN layer converts an output data level value into the number of spikes corresponding to a rate proportional to a size of the output data level value of the output neuron in the ANN layer and transmits (input) the number of spikes to each input neuron of the SNN layer.

Similarly, when connecting from the SNN layer in the intermediate layer group 120 to the ANN layer in the output layer group 130 (\textcircled{2}), an output neuron of the SNN layer transmits (inputs) the information (or data) to an input neuron of the connected ANN layer. In this way, when transmitting the information (or data) from the SNN layer to the ANN layer (\textcircled{2}), the output neuron of the SNN layer converts the spike signal into the level value and transmits (inputs) the level value.

More specifically, depending on whether an activation function of the SNN layer is applied, when the activation function is applied to the SNN layer, the output neuron of the SNN layer transmits (inputs) a value obtained by dividing the sum of the number of spike firings fired during an N time step (or a specified time, or N sampling times) of the spike signal divided by N as level values of the ANN input neuron (i.e., the input neuron of the ANN layer).

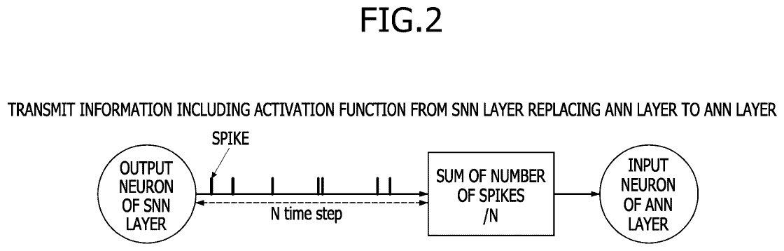

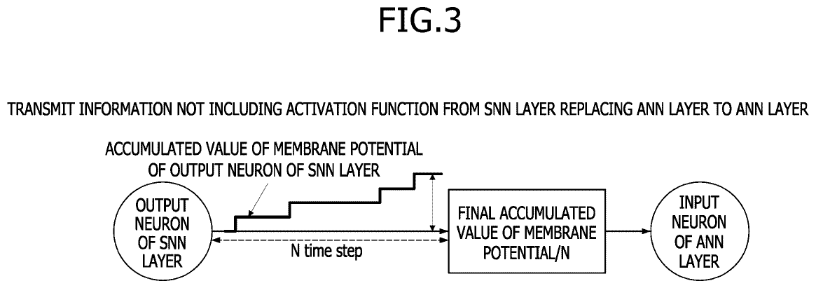

When the activation function is not applied to the SNN layer, the output neuron of the SNN layer transmits (inputs) a level value calculated by dividing a final accumulated value of a membrane potential of the output neuron of the SNN by N as the level value of the ANN input neuron (i.e., the input neuron of the ANN layer) (see FIGS. 2 and 3). In this case, the level value calculated by dividing the final accumulated value of the potential by N may be normalized so that it may become an appropriate input value of the ANN layer.

FIGS. 2 and 3 are exemplary diagrams for describing a signal conversion method when transmitting information from a spiking neural network (SNN) layer to an analog neural network (ANN) layer in FIG. 1.

Referring to FIG. 2, when the information is transmitted from the SNN layer (i.e., the SNN layer that replaces the ANN layer, including the activation function) to the ANN layer, the output neuron of the SNN layer transmits (inputs) the level value calculated by dividing the sum of the number of spike firings fired during the N time step (or a specified time, or N sampling times) in the output neuron of the SNN layer by N to the input neuron of the ANN layer.

In this case, the value of the N time step is not a fixed value and may be changed for the purpose of improving performance, if necessary.

For reference, a membrane potential (MP) of each SNN output neuron (i.e., the output neuron of each SNN layer) is determined by the sum of the values obtained by multiplying the spike signals fired from each input neuron connected by synapses by weights of the corresponding synapses. Then, when the membrane potential of each SNN output neuron (i.e., the output neuron of each SNN layer) becomes greater than a specified threshold value, the spike is fired. In addition, the membrane potential of the corresponding SNN output neuron that fires the spike may be lowered by subtracting the threshold value, or initialized to 0.

Referring to FIG. 3, when the information is transmitted from the SNN layer in which the activation function is omitted (i.e., the SNN layer that replaces the ANN layer) to the ANN layer, the output neuron of the SNN layer transmits (inputs) the level value calculated by dividing the final accumulated value of the membrane potential during the N time step (or a specified time, or N sampling times) in the output neuron of the SNN layer by N to the input neuron of the ANN layer.

In this case, the value of the N time step is not a fixed value and may be changed for the purpose of improving performance, if necessary.

In this case, the level value calculated by dividing the final accumulated value of the potential by N may be normalized so that it may become an appropriate input value of the ANN layer.

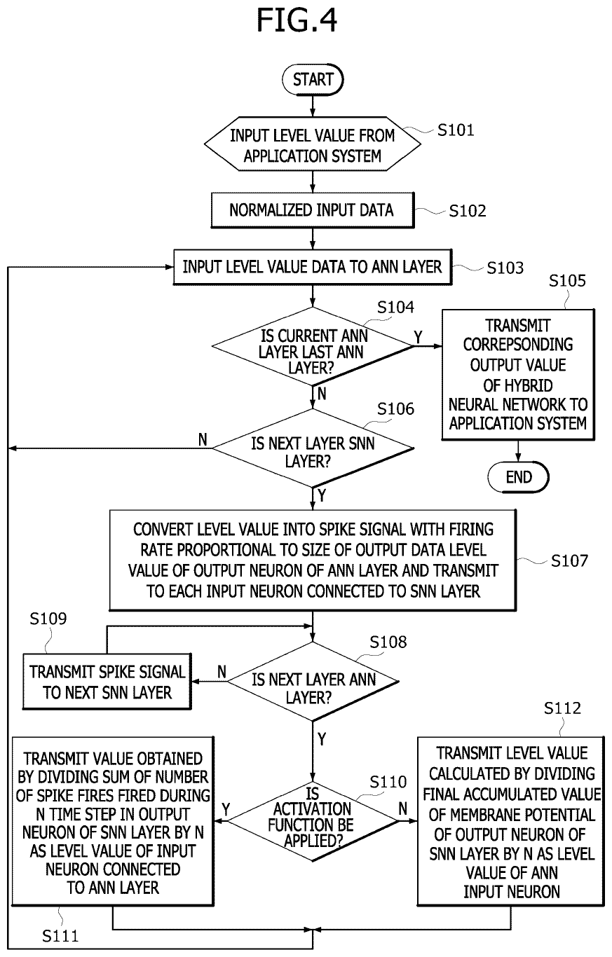

FIG. 4 is a flowchart for describing a method of operating a hybrid neural network apparatus of an ANN and an SNN according to an embodiment of the present invention.

Referring to FIG. 4, the hybrid neural network apparatus 100 (or processor) of the ANN and the SNN receives a value having a level (i.e., a level value) from the application system (S101).

In this case, the level value input from the application system is normalized to a value suitable for each input neuron of the ANN layer and input (S102), and the normalized level value is input to the ANN layer (S103).

Depending on whether the current ANN layer is the last ANN layer in the output layer group 130 (S104), when it is the last ANN layer in the output layer group 130 (Y of S104), the final output value of the hybrid neural network in the form required by the application system is transmitted to the application system (S105), and the operation of the hybrid neural network ends.

When the current ANN layer is not the last ANN layer in the output layer group 130 (N of S104), depending on whether the next layer in the current ANN layer is the SNN layer in the intermediate layer group 120 (S106), when the next layer is not the SNN layer in the intermediate layer group 120 (N of S106), the process of transmitting (inputting) the level value of the output neuron of each ANN layer in the input layer group 110 to the level value of the input neuron of each ANN layer is repeated (S103 to S106).

When the next layer in the current ANN layer is the SNN layer in the intermediate layer group 120 (Y of S106), the level value is converted into a spike signal with the number of times of firing corresponding to a rate proportional to the size of the output data level value of the output neuron of the ANN layer and transmitted (input) to each input neuron connected to the SNN layer (S107).

Depending on whether the next layer in the current SNN layer is the ANN layer (S108), when the next layer in the current SNN layer is not the ANN layer in the output layer group 130 (N of S108), the process of transmitting (inputting) the spike signal of the output neuron of the current SNN layer to the input neuron of the next SNN layer is repeated (S108 and S109).

when the next layer in the current SNN layer is the ANN layer in the output layer group 130 (Y of S108), depending on whether the activation function is set to be applied to the SNN layer (S110), when the activation function is to be applied (Y of S110), the value obtained by dividing the sum of the number of spike firings fired during the N time step (or specified time, or N sampling times) in each output neuron of the SNN layer by N is transmitted (inputted) as the level value of the input neuron (i.e., the input neuron of the ANN layer) connected to the ANN layer (S111).

When the next layer in the current SNN layer is the ANN layer in the output layer group 130 (Y of S108) and the activation function is not applied to the SNN layer (N of S110), the level value calculated by dividing the final accumulated value of the membrane potential of each output neuron of the SNN layer by N is transmitted (input) as the level value of the ANN input neuron (i.e., the input neuron of the ANN layer) (S112).

In this case, the level value calculated by dividing the final accumulated value of the potential by N may be normalized so that it may become an appropriate input value of the ANN layer.

As a result, according to the hybrid neural network apparatus 100 according to the present embodiment, the input layer group 110 and the output layer group 130 use at least one ANN layer, and the intermediate layer group 120 uses at least one SNN layer, thereby minimizing the inefficient configuration additionally required for the conversion of the level values into the spike signals when transmitting the information between the layers, and enabling the low-power operation which is an advantage of the SNN.

In this way, according to the present embodiment, even when converting the ANN layer with the activation function into the SNN layer, it is possible to expect the effect of reflecting the perceptron operation by transmitting the average spike output value during the N time step from the SNN layer to the ANN layer. In addition, according to the present embodiment, when in the SNN, the information data transmitted from the previous layer for the spike input is stored in the membrane potential and when the information data is converted into the level value of the ANN that does not use the activation function in the spike signal of the SNN, there is an effect that enables the corresponding membrane potential value where the information data is stored to be converted into the level value without loss.

According to one aspect of the present invention, it is possible to configure the hybrid neural network including the ANN and the SNN.

According to another aspect of the present invention, it is possible to convert the transmission information data form of the output spike signal of the SNN into the input level value of the ANN when the layers of the SNN are configured between the layers of the ANN in one neural network system together.

What is claimed is:

1. A hybrid neural network apparatus, comprising:
an input layer group comprising at least one analog neural network (ANN) layer and trained by information or data input from an application system;
an intermediate layer group comprising at least one spiking neural network (SNN) layer and trained by a received training result of the input layer group; and
an output layer group comprising at least one ANN layer, trained by a received training result of the intermediate layer group, and then outputting a final training result to the application system.

2. The hybrid neural network apparatus of claim 1, wherein operations of the input layer group, the intermediate layer group, the output layer group, and each ANN layer and each SNN layer in each layer group are performed under control of a processor.

3. The hybrid neural network apparatus of claim 1, wherein the information or data input from the application system is normalized to have a size or form suitable for an input of each ANN layer in the input layer group.

4. The hybrid neural network apparatus of claim 1, wherein, when connecting from the ANN layer in the input layer group to the SNN layer in the intermediate layer group, an output neuron of the ANN layer transmits information or data to an input neuron of the connected SNN layer.

5. The hybrid neural network apparatus of claim 4, wherein the output neuron of the ANN layer converts the output data level value into the number of spikes corresponding to a rate proportional to a size of the output data level value of the output neuron in the ANN layer and transmits the number of spikes to each input neuron of the SNN layer.

6. The hybrid neural network apparatus of claim 1, wherein, when connecting from the SNN layer in the intermediate layer group to the ANN layer in the output layer group, an output neuron of the SNN layer transmits information or data to an input neuron of the connected ANN layer.

7. The hybrid neural network apparatus of claim 6, wherein the output neuron of the SNN layer converts a spike signal into a level value and transmits the level value.

8. The hybrid neural network apparatus of claim 7, wherein the output neuron of the SNN layer transmits, as the level value of the input neuron of the ANN, a value obtained by dividing a sum of the number of spike firings fired during an N time step of the spike signal by N when an activation function is applied.

9. The hybrid neural network apparatus of claim 7, wherein, when an activation function is not applied, the output neuron of the SNN layer transmits a level value calculated by dividing a final accumulated value of a membrane potential of the output neuron of the SNN by N as the level value of the input neuron of the ANN layer.

10. The hybrid neural network apparatus of claim 9, wherein the membrane potential of the output neuron of the SNN layer is determined by a sum of values obtained by multiplying the spike signals fired from each input neuron connected by synapses by weights of the corresponding synapses.

11. The hybrid neural network apparatus of claim 10, wherein the output neuron of the SNN layer fires a spike when the membrane potential of the output neuron of the SNN layer becomes greater than a specified threshold value, and
the membrane potential of the corresponding SNN output neuron that fires the spike is lowered by subtracting the threshold value, or initialized to 0.

12. A method of operating a hybrid neural network apparatus, comprising:
training an input layer group comprising at least one analog neural network (ANN) layer using information or data input from an application system;
training an intermediate layer group comprising at least one spiking neural network (SNN) layer by a received training result of the input layer group; and
training an output layer group comprising at least one ANN layer by a received training result of the intermediate layer group, and then outputting a final training result to the application system.

13. The method of claim 12, wherein the information or data input from the application system is normalized to have a size or form suitable for an input of each ANN layer in the input layer group.

14. The method of claim 12, wherein, when connecting from the ANN layer in the input layer group to the SNN layer in the intermediate layer group, an output neuron of the ANN layer transmits information or data to an input neuron of the connected SNN layer.

15. The method of claim 14, wherein the output neuron of the ANN layer converts the output data level value into the number of spikes corresponding to a rate proportional to a size of the output data level value of the output neuron in the ANN layer and transmits them to each input neuron of the SNN layer.

16. The method of claim 12, wherein, when connecting from the SNN layer in the intermediate layer group to the ANN layer in the output layer group, an output neuron of the SNN layer transmits information or data to an input neuron of the connected ANN layer.

17. The method of claim 16, wherein the output neuron of the SNN layer converts a spike signal into a level value and transmits the level value.

18. The method of claim 17, wherein the output neuron of the SNN layer transmits, as the level value of the input neuron of the ANN, a value obtained by dividing a sum of the number of spike firings fired during an N time step of the spike signal by N when an activation function is applied.

19. The method of claim 17, wherein, when an activation function is not applied, the output neuron of the SNN layer transmits a level value calculated by dividing a final accumulated value of a membrane potential of the output neuron of the SNN by N as the level value of the input neuron of the ANN layer.

20. The method of claim 19, wherein the membrane potential of the output neuron of the SNN layer is determined by a sum of values obtained by multiplying the spike signals fired from each input neuron connected by synapses by weights of the corresponding synapses.
